(19) United States
(12) Patent Application Publication
(10) Pub. No.: US 2023/0247333 A1
(43) Pub. Date: Aug. 3, 2023

(54) Solar-Powered Device for Monitoring Oil Well Operating Status

(71) Applicant: Randy Krall, Albuquerque, NM (US)

(72) Inventor: Randy Krall, Albuquerque, NM (US)

(21) Appl. No.: 18/092,250

(22) Filed: Dec. 31, 2022

Related U.S. Application Data
(60) Provisional application No. 63/306,416, filed on Feb. 3, 2022.

(51) Int. Cl. H04Q 9/00

(52) U.S. Cl. CPC H04Q 9/00; H04Q 2209/43

(57) ABSTRACT

The present invention comprises a Data Monitoring System that comprises one or more solar-powered and battery-operated sensors that are wirelessly connected to a microprocessor that is housed in a waterproof enclosure. The monitoring system and method of use includes wireless means for transmitting the sensor(s) measurements to an Internet server via the Cloud for real-time analysis and control of a machine that has at least one moving part. The innovative monitoring device leverages state-of-the-art sensing and computing technology for generating low cost, high-resolution, real-time measurements and timely reporting of the machine's motion and energy utilization, using a variety of sensors, including: temperature, motor voltage, motor current, wellhead gas pressure, and accelerometer sensors. The machine being monitored can be a pumpjack oil well pump.

### CROSS-REFERENCE TO RELATED APPLICATIONS

This application claims the priority benefit of U.S. Provisional Patent Application Ser. No. 63/306,416 filed Feb. 3, 2022, which is incorporated herein by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to telemetric methods and devices for monitoring operating characteristics of a machine with at least one moving part (e.g., a “pumpjack” oil well pump) and then wirelessly communicating said operating characteristics to an Internet server via the Cloud for enabling real-time performance analysis and control of the machine. The purpose of the invention is to improve the efficiency of pumpjack pumping operations and reduce extended periods of downtime that result in lost production from oil wells.

### Description of Related Art

FIG. 1 shows a schematic elevation view of a commonly-used pumpjack oil well pump machine 1. A diesel/gasoline or electric-powered motor 2 drives a gear reducer 3, which in turn rotates a counterweight 4 that is connected to a crank arm 15. The crank arm 15 is attached to a proximal end of a reciprocating pumpjack arm 5 (“walking beam 5”) and causes the proximal end of pump arm 5 to cyclically move up and down. This, in turn, causes the pumpjack arm 5 to reciprocate about a pivot point 17 that is supported by a supporting structure 11 (“Samson Post”). A rigid “sucker” rod 6 is attached to the distal end of pump arm 5, which has a curved head 13 (“horsehead block”) structure that the proximal end of sucker rod 6 is connected to. The distal (downhole) end of sucker rod 6 is connected to a down-hole pump 19 that is suspended inside an oil well drill string pipe 7. Oscillating up/down movement of the sucker rod 6 causes the downhole pump 19 to cyclically pump a bolus of oil into an optional storage tank 8. Oil that is pumped by pump 19 can be stored in adjacent storage tank 8. The monitoring device 9 is attached (e.g., magnetically) to an upper part of reciprocating pumpjack arm 5, where the solar panel is not shadowed. The monitoring device 9 can be attached to the distal end of pumpjack arm 5.

Existing pumpjack monitoring devices are generally complex devices and use expensive sensors. They do not store or transmit digital measurements of pumpjack characteristics in a format suitable for enabling efficient real-time analysis and control using, for example, neural analysis techniques. Also, existing monitoring devices do not provide reliable, remote communications to an Internet server via the Cloud (Internet-of-Things, IoT) for real-time notifications. Against this background, the present invention was developed.

### SUMMARY OF THE INVENTION

The present invention comprises a Data Monitoring System that comprises one or more solar-powered and battery-operated sensors that are wirelessly connected to a microprocessor that is housed in a waterproof enclosure. The monitoring system and method of use includes wireless means for transmitting the sensor(s) measurements to an Internet server via the Cloud for real-time analysis and control of a machine that has at least one moving part. The innovative monitoring device leverages state-of-the-art sensing and computing technology for generating low cost, high-resolution, real-time measurements and timely reporting of the machine's motion and energy utilization, using a variety of sensors, including: temperature, motor voltage, motor current, wellhead gas pressure, and accelerometer sensors. The machine being monitored can be a pumpjack oil well pump.

### BRIEF DESCRIPTION OF THE SEVERAL VIEWS OF THE DRAWING(S)

FIG. 1 shows a schematic elevation view of a common pumpjack oil well pump.

FIG. 2 shows an example of a schematic layout of the components of a Solar Power Supply, according to an embodiment of the present invention.

FIG. 3 shows an example of a schematic layout of the components of a Sensor Array, according to an embodiment of the present invention.

FIG. 4A shows a plan view of an example of a schematic layout of the components of a waterproof Magnetic Enclosure that houses an Integrated data module and Power Supply, according to an embodiment of the present invention.

FIG. 4B shows a cross-section view of an example of a schematic layout of the components of a waterproof Magnetic Enclosure that houses an Integrated data module and Power Supply, according to an embodiment of the present invention.

FIG. 5 shows an example of a schematic layout of a Modem connected to a long-range transmitting antenna, according to an embodiment of the present invention.

FIG. 6 shows an example of a schematic layout of an Integrated Data Module comprising a Microprocessor running real-time data collection and communication software, according to an embodiment of the present invention.

FIG. 7 shows an example of a schematic layout of a Satellite Location Device comprising a GPS receiver connected to a satellite antenna, according to an embodiment of the present invention.

FIG. 8 shows an example of a schematic layout of the components of an Integrated Data Module, according to an embodiment of the present invention.

FIG. 9 shows a schematic exploded view of an example of the major components of a Data Monitoring System 50, according to an embodiment of the present invention.

### DETAILED DESCRIPTION OF THE INVENTION

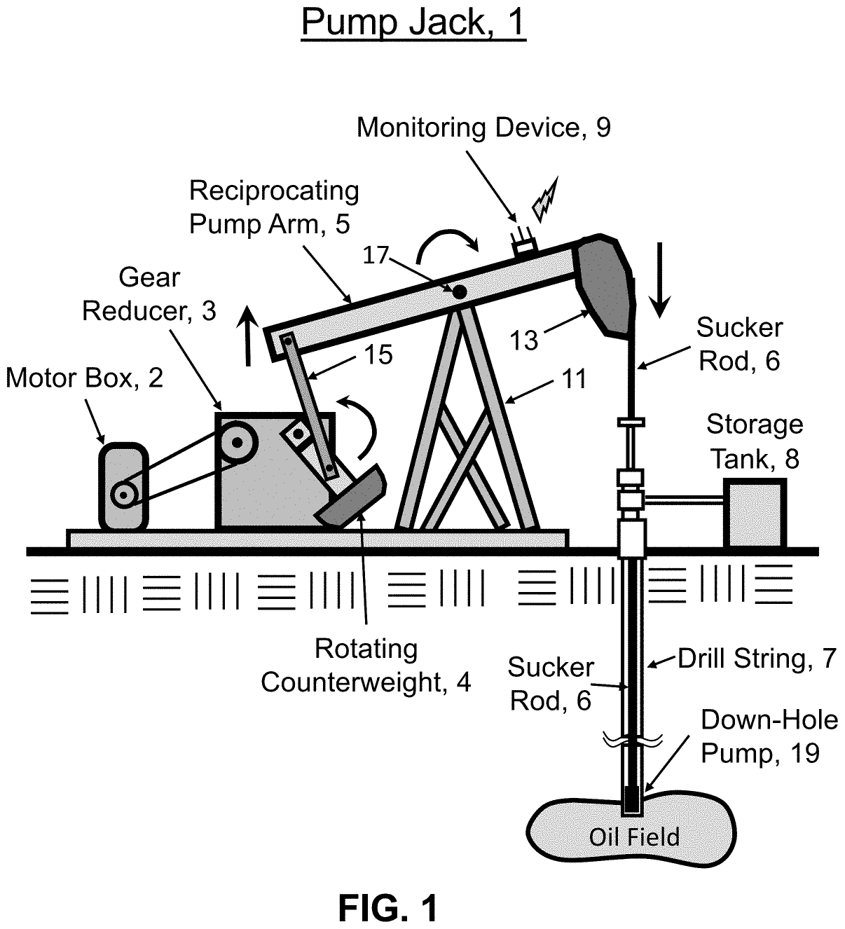

FIGS. 1-9 show examples of different embodiments of the present invention. The invention relates to an integrated, telemetric data monitoring system 50 comprising methods and devices for monitoring the operating characteristics of a “pumpjack” oil well pump 1 (or any other machine that has at least one moving part). The characteristics being monitored are wirelessly communicated to an Internet server (i.e., via the “Cloud”) for real-time analysis and control. Alternatively, the monitored data can be saved in a local memory, and then transmitted to the Cloud at periodic intervals (e.g., twice a day) in “burst mode”. The purpose of the invention is to (a) improve the efficiency of pumpjack pumping operations and to (b) reduce extended periods of downtime that result in lost production from oil wells.

The inventive monitoring device 9 can periodically and/or continuously measure the cyclical movement of a pumpjack's arm 5, and other operating characteristics of the pumpjack 1, and then report those characteristics to an Internet server via the Cloud in a format suitable for advanced quantitative analysis. The data format, while still being developed, will likely include: (a) data compression and possibly (b) encryption to reduce bandwidth and decrease access by unauthorized parties. Also, the system produces high quality data suitable for subsequent analysis using a neural network and/or other statistical methods. The subsequent analysis permits the operators to optimize the performance of their oil well(s).

A first embodiment of a data monitoring system can comprise the following components:
1. a Power supply;
2. a Sensor array;
3. an Enclosure;
4. a Modem;
5. a Microprocessor; and
6. a Satellite-based GPS position sensor.

The solar power supply charges one or more on-board batteries and supplies operating power to the other components. The sensor array, which can include both internal and external sensors, utilizes inexpensive, yet rugged, components to perform critical measurements of operating conditions required to optimize the machine's performance. The sensor array measures the machine's operating condition, including, but not limited to: movements of one or more parts, electrical power consumption, temperature, pressure, and other parameters. An enclosure, which can be magnetized, houses most of the components in a waterproof and dustproof housing that withstands the harsh conditions of an oilfield and can be easily installed by oilfield personnel. The modem periodically communicates digital operating parameters to an Internet server via the Cloud, which enables remote analysis over the Internet. The modem can operate continuously, or periodically to minimize power requirements. The microprocessor, and the custom software it executes, (a) collects information from the sensor array, (b) performs data analysis, and (c) communicates the digital results in a timely fashion via the modem to the Cloud. Wi-Fi communications are available in some, but not most, oilfields. The monitoring device's long-range antenna transmits digital data to a cell tower. From there, it goes over the Internet to one or more servers. Finally, the satellite-based GPS position sensor provides precise information about the machine's location. The machine with at least one moving part can be a pumpjack oil well pump.

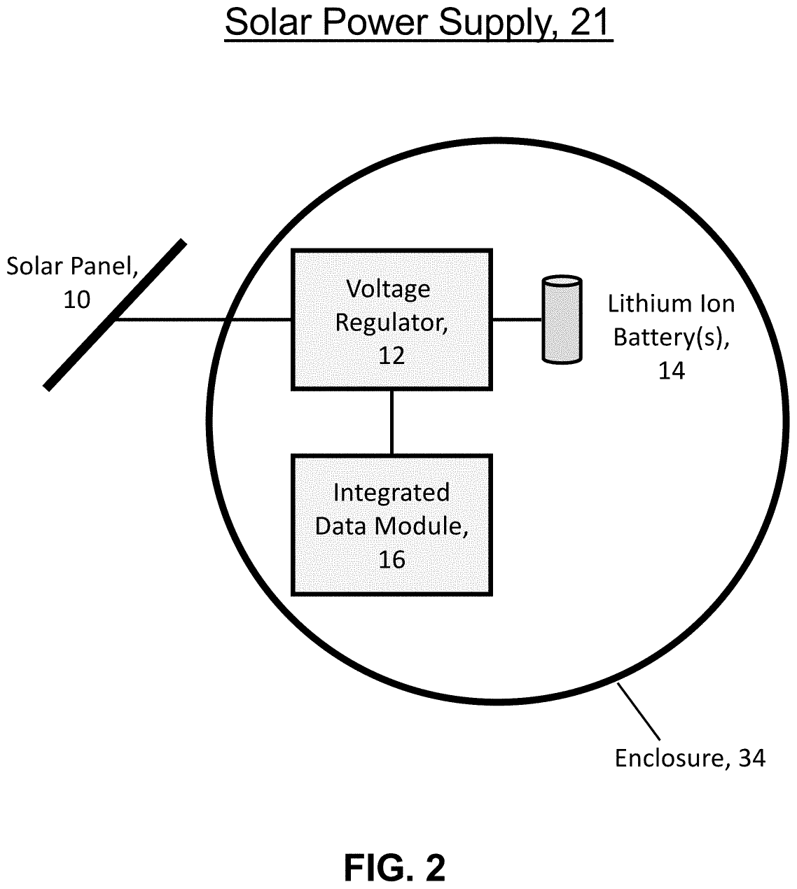

FIG. 2 shows an example of a schematic layout of a Solar Power Supply 21, according to an embodiment of the present invention. The solar power panel 10 charges an on-board battery 14 (which can comprise one or more lithium-ion batteries) via voltage regulator 12 that supplies low-voltage (e.g., 3-3.3 V) power to all of the other components, including the Integrated Data Module 16.

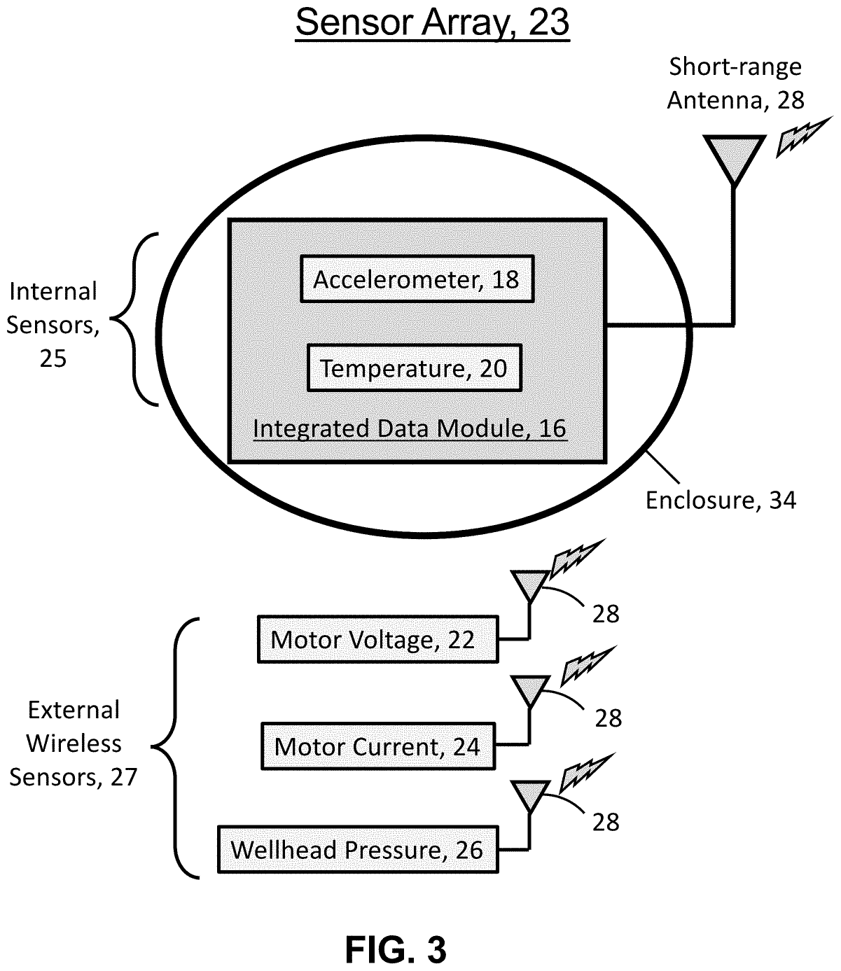

FIG. 3 shows an example of a schematic layout of a Sensor Array 23, according to an embodiment of the present invention. Sensor array 23 can comprise both internal sensors 25 and external sensors 27. Examples of internal sensors 25 include: accelerometer 18, and temperature gauge 20, which are mounted inside of enclosure 34. Examples of external sensors 27 include: motor voltage and motor current sensors 22 and 24, respectively, and wellhead gas pressure sensor 26. The internal sensors are contained in a waterproof enclosure 34 that is easily installed by oilfield personnel and that doesn't require any drilling to attach the enclosure 34 to the pumpjack 1. A modem 40 (not shown) periodically (or continuously) communicates the monitored data to the Cloud via an Internet server 52. A microprocessor 44 (not shown) disposed on an Integrated Data Module 16 collects information from one or more sensors in the sensor array 23 and performs initial analysis of the sensors' data. It then communicates the results (e.g., pumpjack strokes-per-minute, daily stroke totals, and daily run time) to the Internet. Strokes-per-minute provides useful operating information about the well's performance in essentially real time via the modem 40 to the Internet 52 using TCP/IP protocol(s). The internal temperature sensor 20 and the internal accelerometer sensor 18 are hard-wired to the Integrated Data Module 16, whereas the external motor voltage sensor 22, motor current sensor 24, and wellhead gas pressure sensor 26 can be connected in the pumpjack's electrical box (not shown) and wirelessly connected via radio short-range antennas 28 (using Bluetooth protocol) to the Integrated Data Module 16 of System 50 for additional measurements and analysis.

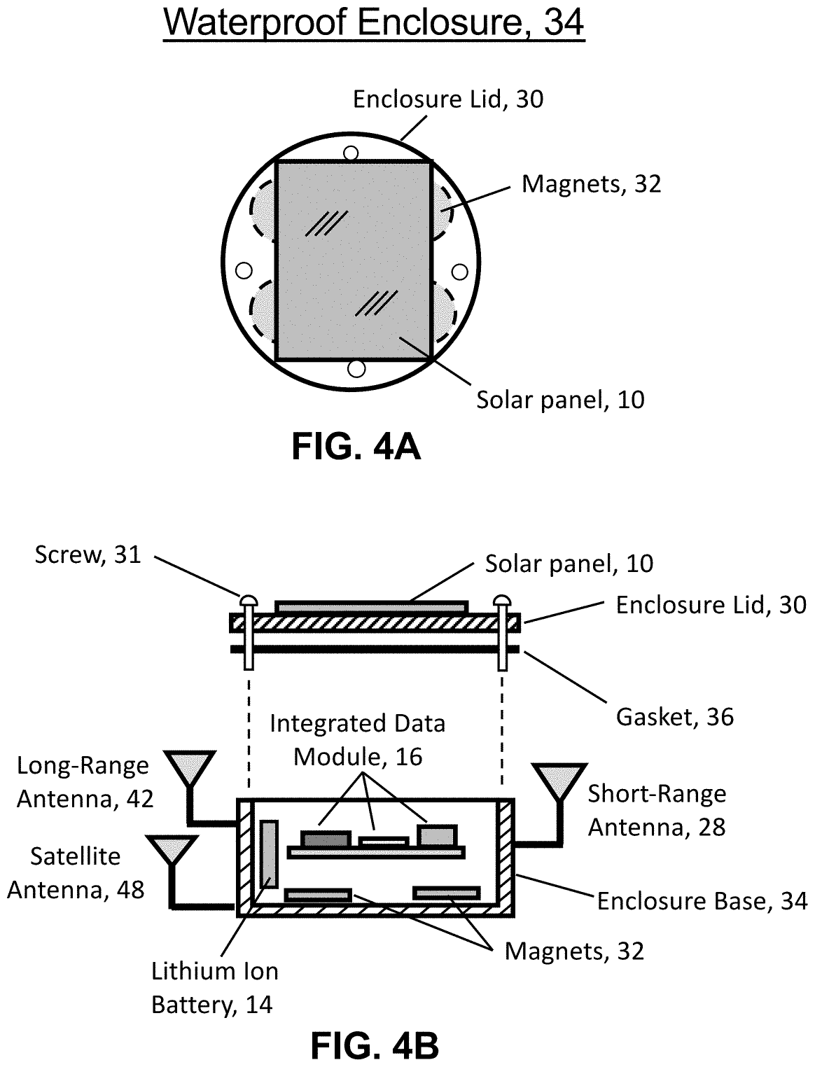

FIGS. 4A and 4B shows a plan view and a cross-section view, respectively, of an example of a schematic layout of a waterproof enclosure 34 for holding an Integrated Data Module 16 and lithium-ion battery 14, according to an embodiment of the present invention. Four high-strength magnets 32 are glued to the bottom of enclosure 34 (which can be made of a plastic or other non-magnetic material) that securely holds enclosure 34 to the top of pumpjack's reciprocating “walking” arm 5. Solar panel 10 is mounted to the enclosure's removable lid 30 and is mounted on top of arm 5 in such a way as to maximize solar energy gain. Gasket 36 is used to waterproof enclosure 34. The short-range receiving antenna 28 and long-range transmitting antenna 42, and satellite antenna 48 are shown attached to enclosure 34. The long-range antenna 42 communicates modem data to one or more cell towers (i.e., LTE cellular).

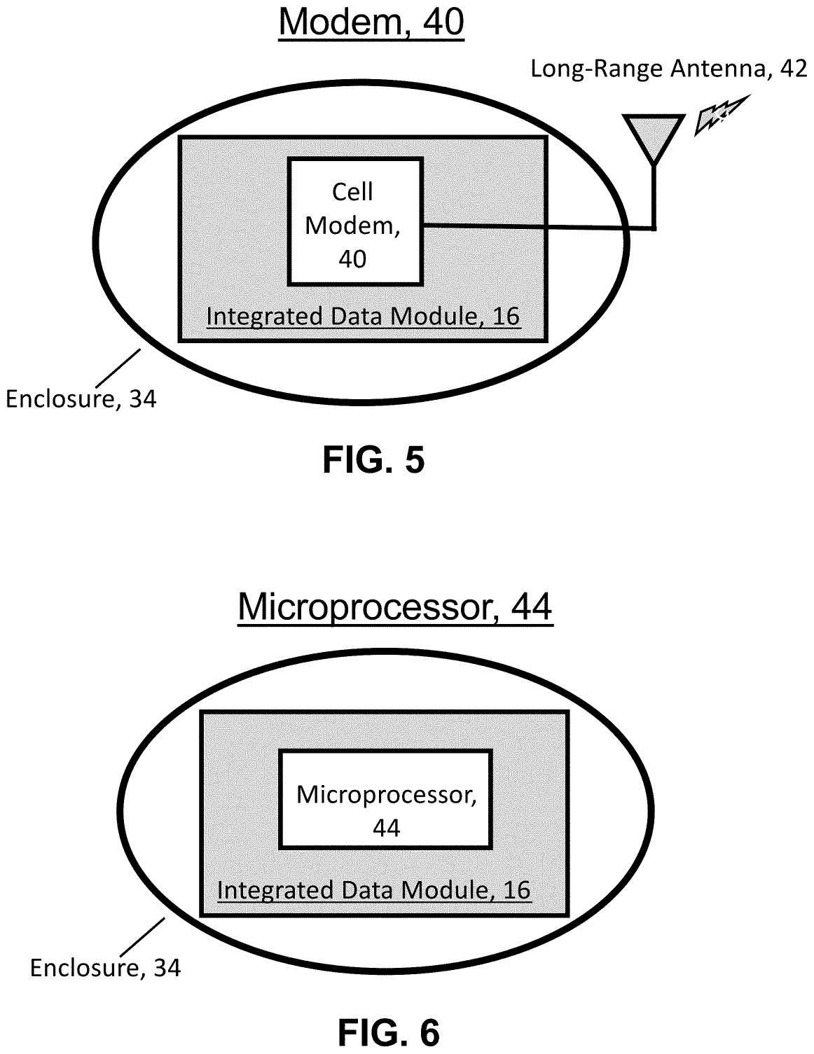

FIG. 5 shows an example of a schematic layout of a Cell Modem 40 that is disposed on Integrated Data Module 16, and connected to long-range antenna 42, according to an embodiment of the present invention. Modem 40 is connected to the microprocessor's serial interface to receive instructions to upload the pumpjack's operating data and to allow periodic configuration updates to the microprocessor's parameters. The modem can use TCP/IP communication protocols.

FIG. 6 shows an example of a schematic layout of a Microprocessor 44 disposed on Integrated Data Module 16, which runs data collection and communication software, according to an embodiment of the present invention. Microprocessor 44 is connected to all of the sensors in the sensor array 23, the modem 40, and the satellite GPS monitoring system via appropriate analog and digital inputs.

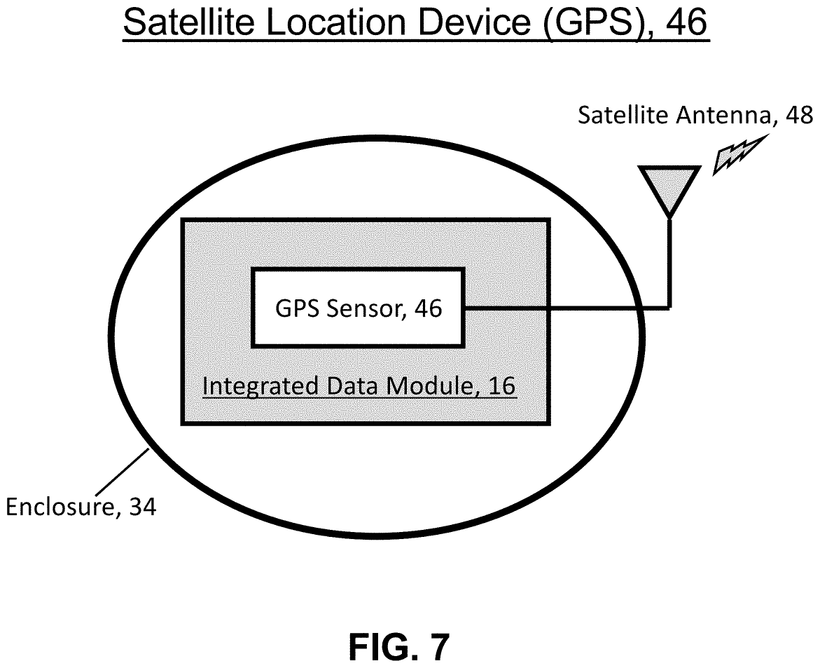

FIG. 7 shows an example of a schematic layout of a Satellite Location Device (GPS) 46, comprising a GPS receiver 46 disposed on Integrated Data Module 16, and operably connected to satellite antenna 48, according to an embodiment of the present invention. Satellite antenna 48 transmits digital position data to an Internet server via the Cloud 52.

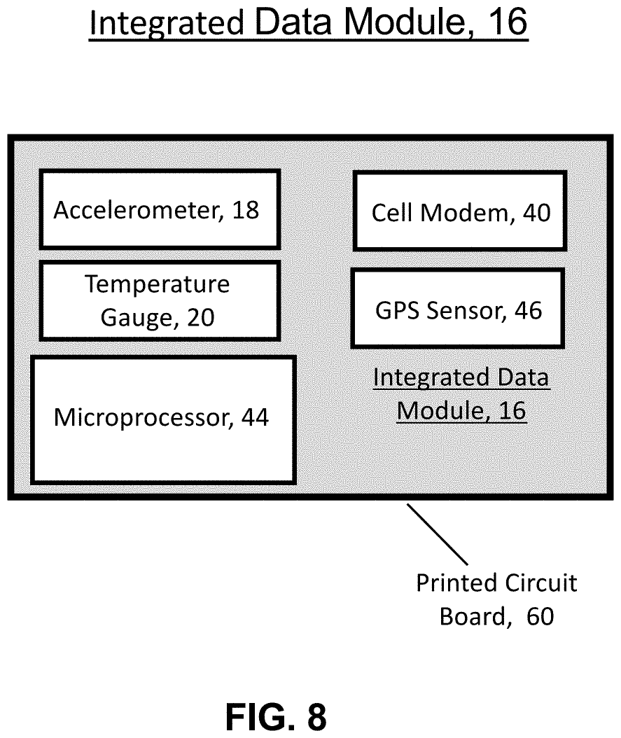

FIG. 8 shows an example of a schematic layout of an Integrated Data Module 16, according to an embodiment of the present invention, comprising: a printed circuit board 60, an accelerometer sensor 18, temperature gauge 20, microprocessor 44, GPS receiver 46, and Cell Modem 40 all mounted to circuit board 60, along with related digital and analog I/O connections (not shown).

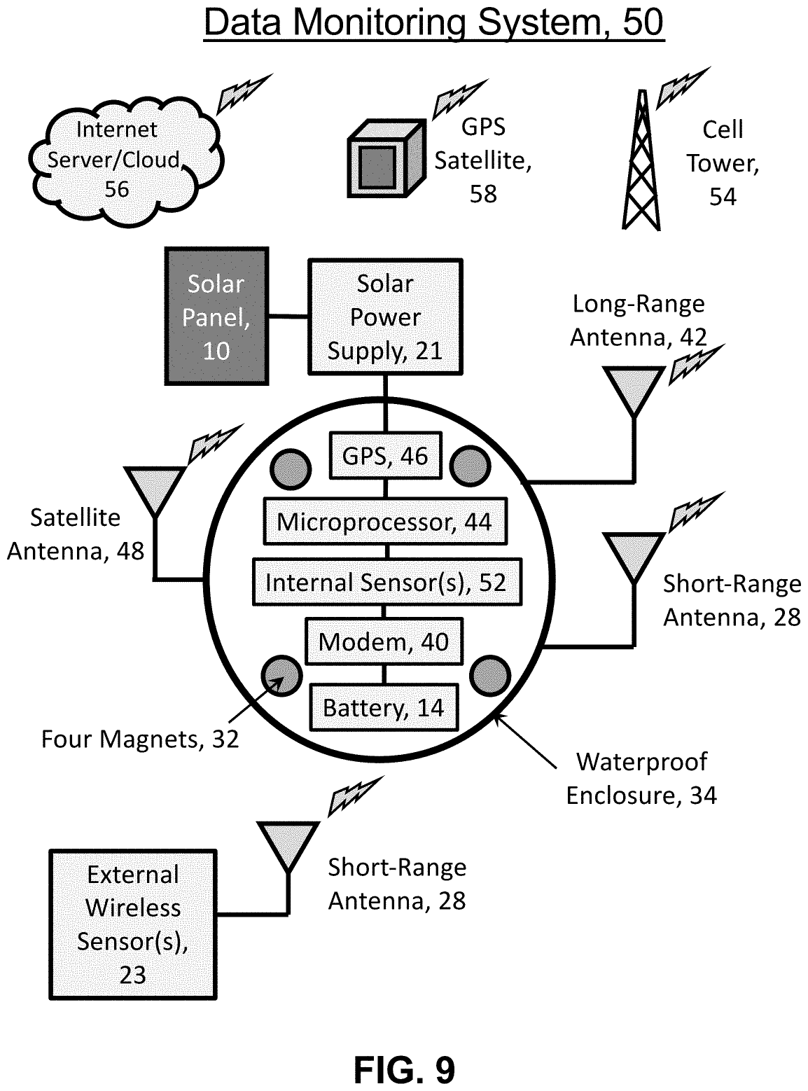

FIG. 9 shows a schematic exploded view of an example of the principal components of a Data Monitoring System 50, according to an embodiment of the present invention. The principal components include: a GPS sensor 46, a Microprocessor computer 44, one or more Internal Sensor(s) 27, one or more External Wireless Sensor(s) 27, a Modem 40, and a Battery 14, all housed inside of Enclosure 34 (except for the external sensors 27, which are mounted outside of the enclosure 34). Solar power supply 21 provides low-voltage electricity to the principal components. Data monitoring system 50 further comprises three different types of powered antennas: Short-Range Antenna 28, Long-Range Antenna 42, and Satellite Antenna 48. The long-range antenna 42 transmits digital data to a nearby cell tower 54, which then uploads the data to an Internet server 56 using Cloud access protocols. The satellite antenna 48 communicates GPS position data of the GPS sensor 46 to GPS satellite 58 orbiting the Earth.

Referring still to FIG. 9, data monitoring system 50 operates as follows. Solar power supply 21 supplies sufficient voltage and current to the principal components for correct operation in adverse conditions, around the clock. The array 23 of external and internal sensors utilize inexpensive, yet rugged, components to perform critical measurements of the operating conditions required to optimize the pump's performance. The sealed, magnetic enclosure 34 is water-proof and dust-proof, which permits all components to function reliably in harsh oilfield conditions. Modem 40 provides reliable digital communications in remote environments typical in the oilfield. Modem 40 can be programmed to operate infrequently to minimize power requirement. We normally report monitored data 10 times/hour, but this can be easily reduced to one per hour or once per day to prolong battery life. Microprocessor 44, along with custom software that it executes, optimally makes the required sensor measurements and manipulates the measured data to permit efficient and timely uploading of digital data to an Internet server 56 via Cloud-access protocols. Finally, the satellite-based GPS position sensor 46 permits timely updates of the system's geographical location to a GPS satellite 58. Measuring the enclosure's position is characterized by its ease of installation on pumpjack 1, with easy relocation to other pumping units, when needed.

waterproof enclosure 34), and voltage regulator 12 (along with appropriate circuitry). The sensor array's motion detectors (e.g., one or more accelerometers 18) are mounted inside the waterproof enclosure 34 to permit direct connection to microprocessor 44. The external voltage and current sensors 23 can be mounted inside a pumpjack's electrical/motor box 2, which uses a short-range wireless radio connection (e.g. Bluetooth) to communicate data with a short-range antenna mounted nearby on enclosure 34. Four powerful magnets are attached inside the bottom of the plastic enclosure 34, which securely holds the monitoring device 9 on the reciprocating “walking” arm 5 or the horsehead block 13 of the pumpjack 1. Modem 40 is connected to a serial

In some embodiments of the present invention, the solar power supply 21 is assembled with lithium-ion battery(s) 14, solar panel 20 (which can optionally be attached to the lid of the interface of microprocessor 44 and receives instructions to upload the pumpjack's monitored data, and to allow periodic “configuration updates” to the microprocessor's parameters. An example of a “configuration update” includes: (a) the well's reporting frequency, (b) the well's GPS location, (c) the pump's volume (size), and (d) the accelerometer's configuration info, such as the axis. The satellite GPS sensor's antenna 48 is positioned atop of the inside of the enclosure's lid 30 to permit a clear view of the sky for optimum data transmission to the GPS satellite 58.

The following is a non-exclusive list of the various types of sensors that can be used by the data monitoring system 50, according to the present invention:

TABLE 1
List of Sensors

Accelerometer
Temperature
Motor Voltage
Motor Current
Wellhead pressure
Microphone(s)

A data monitoring system 50 can be magnetically attached to a distal end of the reciprocating arm 5 of the pumpjack 1 using the magnets 32 attached inside of enclosure 34. Computer software is then configured (upon startup) to periodically report the pump's run status to an Internet server 52 via the Cloud. All components of data monitoring system 50 work closely together to provide optimum monitoring of the pump's performance.

In other embodiments of the present invention, a data monitoring system 50 can be used to monitor physical movements (or other physical or electrical characteristics) of any type of equipment that involves at least one moving part.

The data monitoring system 50 produces high-quality, Internet-of-Things (loT) data that is suitable for analysis with a neural network program, or other statistical methods. Here, “high quality data” means sensor inputs measured with 12 or 16 bits of ND resolution, and algorithmically checked for consistency and repeatability. Use of such a remote analysis permits the pump's operator to optimize the overall performance of their oil well, for example, by adjusting any timers or other local control devices.

In a typical pumpjack machine 1, electricity is used to power an electric motor that drives motor box 2 (the “prime mover”), as shown in FIG. 1. This source of electricity can optionally be used to power the data monitoring system 50 of the present invention, instead of, or in addition to, using a solar panel 10. Then, device 9 could be powered overnight or during extended periods of cloudiness. In other words, the external array of sensors 23 can each be powered by individual solar-charged batteries, or they can use the pumpjack's motor electrical power supply 2 to provide a steady source of electrical power.

The total cost of the innovative data monitoring system 50 can range from $50 to $500, depending on the number of sensors included in the system, and other components, according to the present invention.

With the addition of a second Bluetooth device, then an enhanced Data Monitoring system 50 could remotely shut-down the moving machine (e.g., pumpjack oil well pump). Such a second Bluetooth device could comprise a wireless-enabled relay connected into the machine's motor box (e.g., pumpjack motor box 2).

What is claimed is:

1. A telemetric data monitoring system for monitoring operational performance of a machine with at least one moving part, comprising the following components:
a power supply;
one or more sensor(s) operably connected to the power supply;
a modem operably connected to the power supply;
a microprocessor operably connected to the power supply; and
a Global Positioning Satellite (GPS) position sensor operably connected to the power supply.

2. The telemetric data monitoring system of claim 1, further comprising a waterproof enclosure that houses the microprocessor, the modem, the GPS position sensor, and an accelerometer; wherein the enclosure is attached to the at least one moving part.

3. The telemetric data monitoring system of claim 1, wherein the power supply comprises a solar panel operably connected to a voltage regulator that is operably connected to a lithium-ion battery, wherein the voltage regulator charges the lithium-ion battery during daylight.

4. The telemetric data monitoring system of claim 2, wherein the one or more sensor(s) comprises an accelerometer and a temperature gauge that are both mounted inside of the enclosure and that are both operably connected to the microprocessor.

5. The telemetric data monitoring system of claim 2, further comprising:
one or more external wireless sensor(s) disposed outside of the enclosure;
wherein each external wireless sensor comprises a short-range transmitting antenna that transmits digital data from each external sensor to a single short-range receiving antenna that is operably connected to the microprocessor.

6. The telemetric data monitoring system of claim 5, wherein the one or more external wireless sensor(s) comprises a wireless voltage sensor and a wireless current sensor for monitoring power consumption, and a wireless wellhead gas pressure sensor for measuring gas pressure inside an oil well.

7. The telemetric data monitoring system of claim 5, wherein the one or more external sensor(s) transmit data wirelessly to the short-range receiving antenna using Bluetooth™ protocols.

8. The telemetric data monitoring system of claim 2, wherein a solar panel is mounted to a removable enclosure lid that is attachable to the enclosure's base with a gasket and one or more screws, which seals the enclosure when the lid is attached.

9. The telemetric data monitoring system of claim 8,
wherein the enclosure is made of a non-magnetic material; and
wherein the enclosure further comprises one or magnet(s) attached to the enclosure's base for magnetically attaching the enclosure to an adjacent substrate made of steel or iron.

10. The telemetric data monitoring system of claim 1, further comprising an integrated data module with one or more integrated chips that comprises a microprocessor, an accelerometer, a GPS sensor, a temperature gauge, and a modem.

11. The telemetric data monitoring system of claim 2, further comprising a satellite antenna attached to the enclosure for transmitting monitored data wirelessly from the GPS position sensor to an Internet server by using a Cloud-based software application.

12. The telemetric data monitoring system of claim 2, further comprising a long-range antenna that is attached to the enclosure and that is operably connected to the modem; wherein the long-range antenna transmits monitored data wirelessly from the one or more sensor(s) to an Internet server via the modem by using a Cloud-based software application.

14. The telemetric data monitoring system of claim 9, wherein the enclosure is magnetically attached to a reciprocating “walking” arm of a pumpjack oil well pump.

15. The telemetric data monitoring system of claim 1, wherein software executed by the microprocessor is adjustable in real-time via remote commands.

16. The telemetric data monitoring system of claim 5, further comprising a pumpjack oil well pump, wherein the external sensor(s) utilize the pumpjack's motor electrical power supply to power the external sensor(s).

17. The telemetric data monitoring system of claim 1, wherein the machine comprises a motor; and wherein the monitoring system additionally comprises a wireless-enabled electrical relay operably connected to the machine's motor for controlling the motor's operation.

18. The telemetric data monitoring system of claim 1, wherein a rate at which sensor data is reported is adjustable with a reporting period ranging from 10 times/hour to once-per-day to prolong battery life.

19. A telemetric data monitoring system for monitoring performance of a machine with at least one moving part, comprising the following components:
a power supply;
a modem operably connected to the power supply;
an accelerometer operably connected to the power supply;
a temperature gauge operably connected to the power supply;
a microprocessor operably connected to the power supply; and
a Global Positioning Satellite (GPS) position sensor operably connected to the power supply;
and further comprising:
an enclosure that contains the microprocessor, the modem, the GPS position sensor, and one or more antenna(s) for communicating data via the modem to an Internet server by using a Cloud-based software application;
wherein the power supply comprises a lithium-ion battery contained within the enclosure.

20. An oil well pumpjack telemetric data monitoring system for monitoring performance of a reciprocating pumpjack oil well pump, comprising the following components:
a power supply;
a modem operably connected to the power supply;
a microprocessor operably connected to the power supply; and
a Global Positioning Satellite (GPS) position sensor operably connected to the power supply;
and further comprising:
a waterproof enclosure that contains the microprocessor, an accelerometer, the modem, a temperature gauge, the GPS position sensor; and
wherein the lithium-ion battery is contained within the enclosure; and
wherein the power supply comprises a solar panel operably connected to a voltage regulator that is operably connected to the lithium-ion battery for charging the battery;
and further comprising one or more external wireless sensor(s) that are mounted outside of the enclosure;
wherein each external wireless sensor comprises a short-range antenna that transmits data from the external sensor to a single short-range receiving antenna that is operably connected to the microprocessor;
wherein the enclosure is made of plastic and comprises an enclosure base;
wherein the enclosure further comprises one or magnets securely attached to the enclosure's base; and
further comprising a long-range antenna attached to the enclosure for wirelessly transmitting monitored data from the one or more sensor(s) to an Internet server via the modem using a Cloud-based software application; and
wherein the enclosure is magnetically attachable to a reciprocating “walking” arm of the pumpjack oil well pump.
